(19) United States
(12) Patent Application Publication
(10) Pub. No.: US 2015/0365425 A1
(43) Pub. Date: Dec. 17, 2015

(54) MESSAGE PROTECTION

(71) Applicant: KT Corporation, Seongnam-si (KR)

(72) Inventors: Jae-uk CHA, Seongnam-si (KR); Seokhong KIM, Seoul (KR); Jung-suk PARK, Seoul (KR); Jung-wook LEE, Gwangmyeong-si (KR); Sung-taek JUNG, Yongin-si (KR)

(21) Appl. No.: 14/741,527

(22) Filed: Jun. 17, 2015

(30) Foreign Application Priority Data
Jun. 17, 2014 (KR) 10-2014-0073472

(51) Int. Cl. H04L 29/06

(52) U.S. Cl. CPC H04L 63/123; H04L 63/0876; H04L 63/0457

(57) ABSTRACT

In one example, message protection may include receiving a message, encrypting the received message, storing the encrypted message in a memory, authorizing one or more applications to handle the message, notifying authorized applications of receipt of the message, decrypting the encrypted message, and permitting one of the authorized applications to display the decrypted message.

### TECHNICAL FIELD

The embodiments described herein pertain generally to permitting access to decrypted messages on a host device to authorized devices, so as to protect the messages from unauthorized access by another application on the same host device.

### BACKGROUND

Messaging services including, e.g., SMS (short message service), were originally intended for transmitting text messages of 160 characters or less from one mobile device to another. However, other communication protocols, e.g., MMS (multimedia messaging services), have extended the capabilities of mobile devices to exchange messages that include text and/or multimedia content. In a competitive application market, it is not uncommon for a mobile device to host multiple messaging service applications.

### SUMMARY

In one example embodiment, a method to implement message protection on a device may include receiving a message, encrypting the received message, storing the encrypted message in a memory, authorizing one or more applications to access the encrypted message stored in the memory, notifying the one or more authorized applications of receipt of the message, decrypting the encrypted message, authorizing a first application among the authorized applications to display the decrypted message, and permitting the first application to display the decrypted message.

In another example embodiment, a device includes a communicator to send and receive a message; an encryptor to encrypt the message; a memory to store the encrypted message; and a notifier to notify, a plurality of applications that have authority to access the encrypted message, of receipt of the message. Further, a first application may be installed on the device to receive the notification from the notifier, decrypt the encrypted message, and display the decrypted message. Further still, a second application may be installed on the device to receive the notification from the notifier, and display the encrypted message.

In yet another example embodiment, a computing device may include a memory and a processing unit to receive a message, encrypt the received message and store the encrypted message in the memory, notify authorized applications of receipt of the message, decrypt the encrypted message, display the decrypted message by one of the authorized applications, and display the encrypted message by a second application from among the plurality of applications.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

In the detailed description that follows, embodiments are described as illustrations only since various changes and modifications will become apparent to those skilled in the art from the following detailed description. The use of the same reference numbers in different figures indicates similar or identical items.

FIG. 1 shows an example system configuration in which one or more embodiments of message protection may be implemented, arranged in accordance with one or more embodiments described herein;

FIG. 2 shows an example configuration of an apparatus by which at least portions of message protection may be implemented, arranged in accordance with one or more embodiments described herein;

FIG. 3 shows an example processing flow of operations for implementing at least portions of message protection, arranged in accordance with one or more embodiments described herein;

FIG. 4 shows another example processing flow of operations for implementing at least portions of message protection, arranged in accordance with one or more embodiments described herein;

FIG. 5 shows another example processing flow of operations for implementing at least portions of message protection, arranged in accordance with one or more embodiments described herein;

FIG. 6 shows another example processing flow of operations for implementing at least portions of message protection, arranged in accordance with one or more embodiments described herein;

FIG. 7 shows another example processing flow of operations for implementing at least portions of message protection, arranged in accordance with one or more embodiments described herein;

FIG. 8 shows an example user interface by which at least portions of message protection may be implemented, arranged in accordance with one or more embodiments described herein; and

FIG. 9 shows an example computing device on which and by which at least portions of message protection may be implemented, arranged in accordance with one or more embodiments described herein.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein and illustrated in the drawings, may be arranged, substituted, combined, separated, and designed in a wide variety of different configurations, all of which are explicitly contemplated herein.

Further, an application domain may be regarded as a construct within an execution environment that is a unit of isolation for a process. More particularly, the isolation construct may enable the code executed therein to be loaded from a specified source; the isolation construct may be aborted independent of other such isolation constructs; and processing within the isolation construct may be isolated so that a fault occurring therein does not affect other isolation constructs within the process. In other words, the effects of processing within an isolation construct are not visible to concurrently-running constructs until the overall process is made permanent. Further, for the sake of consistency, the discussion hereafter refers to “applications” and “processes,” both of which may encompass any one of, at least, software programs, and applications, either singularly or in combination.

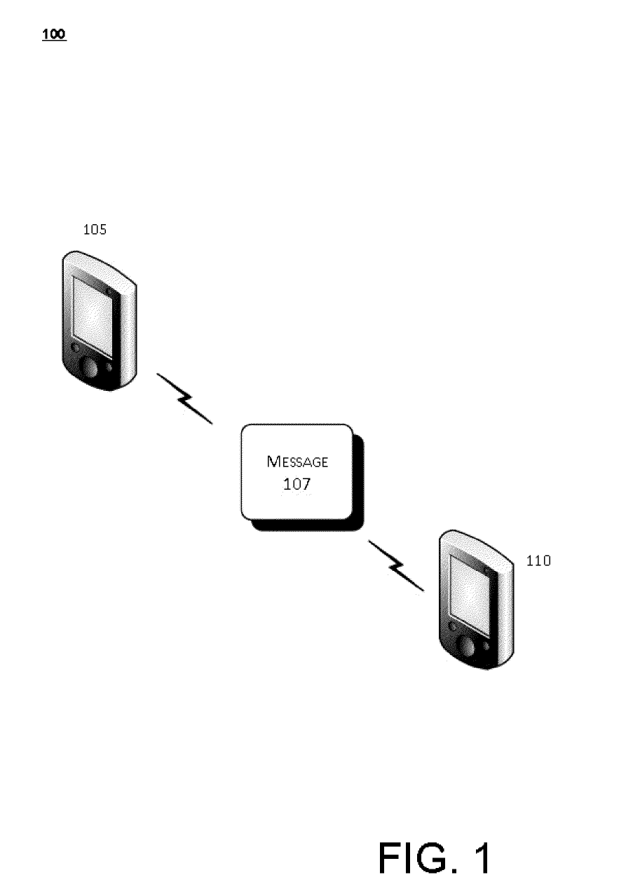

FIG. 1 shows an example system configuration in which one or more embodiments of message protection may be implemented. As depicted, configuration 100 includes, at least, a first client device 105 and a second client device 110. At least client device 105 hosts multiple applications that are capable of exchanging messages that include text and/or multimedia content using known protocols, e.g., SMS, MMS, Bluetooth, etc.

Client device 105, as well as client device 110, may refer to an electronic device that is configured to transmit and receive digital messages over a radio link while moving around a wide geographic area by connecting to a mobile communications network provided by a wireless service provider. Client devices 105 and 110 may be implemented as a portion of a small-form factor portable (or mobile) electronic device such as a mobile phone, cell phone, smartphone, personal data assistant (PDA), a personal media player device, an application specific device, or a hybrid device that include any of the above functions. In addition, or alternatively, client devices 105 and 110 may also be implemented as a personal computer including tablet, laptop computer and non-laptop computer configurations.

As referenced herein, message 107 may refer to a text message, multi-media message, email, etc., which may be transmitted in either direction between client device 105 and client device 110. Thus, message 107 may be a message in SMS, MMS, HTML, etc., format. Of course, the form and format of digital message 107 is not so limited; rather, the above examples are intended to illustrate the variety of messages that may be sent and received in various embodiments of message protection. A multi-media message may include any permutation of text, audio, still images, animation, video, or interactive content.

As referenced herein, message applications may refer to a computer program configured to permit a user thereof to exchange message 107, which may be, e.g., a text message and/or a multimedia message via a wireless text messaging service, the internet, WiMAX™, Wi-Fi™, Bluetooth™, a wireless local area network, and other analog and digital wireless voice and data transmission technologies.

In accordance with at least one embodiment of message protection, message 107 may be transmitted from client device 110 to client device 105. On client device 105, message 107 may be encrypted and then stored in a local or remote memory. One or more applications hosted on client device 105 may have been authorized to access a protected version of message 107, and thus the authorized applications may be notified of receipt of message 107. By message protection, in accordance with the embodiments described herein, authorized applications may be permitted to handle, e.g., at least access decrypted message 107. According to at least one embodiment of message protection, further authorization may be required to display decrypted message 107 even after being authorized to access decrypted message 107. Such further authorization may be implemented in the same manner as the authorization to access the protected version of message 107 described herein.

In accordance with another embodiment of message protection, either of client devices 105 and 100 includes a communicator to send and receive message 107 to the other client device; an encryptor to encrypt received message 107; a memory to store encrypted message 107; and a notifier to notify one or more authorized applications of receipt of message 107. Further, a first application may be installed on the device to receive the notification from the notifier, decrypt encrypted message 107, and display decrypted message 107. As set forth above, further authorization may be required to display decrypted message 107 even after being authorized to access decrypted message 107, and that further authorization may be implemented in the same manner as the authorization to access the protected version of message 107 described herein.

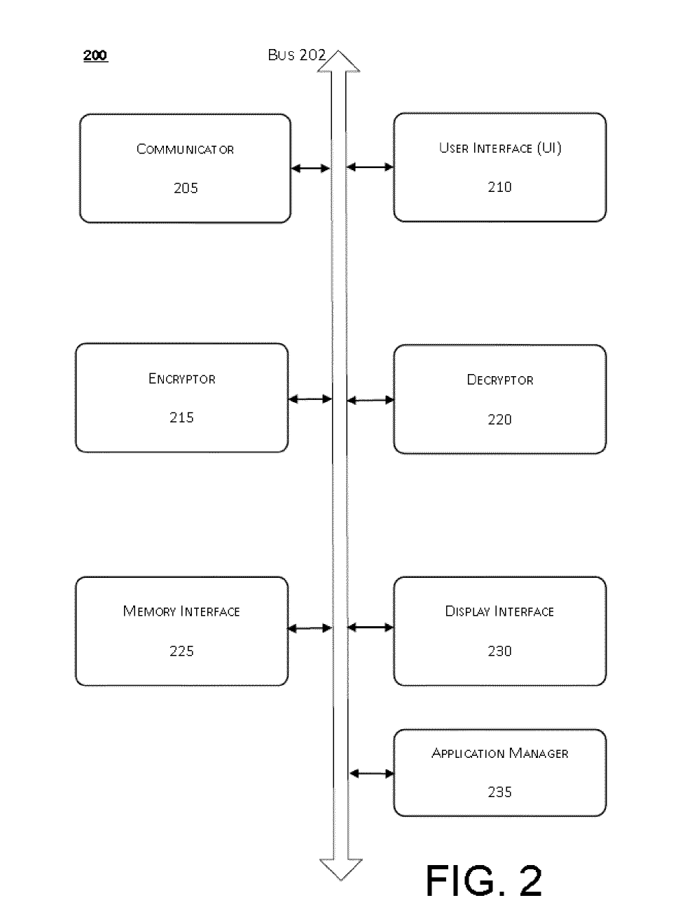

FIG. 2 shows an example configuration of an apparatus 200, by which at least portions of message protection may be implemented. Apparatus 200 may be hosted and implemented, at least in part, by at least one of client 105 and client device 110. Apparatus 200 may include, but not be limited to communicator 205, user interface (UI) 210, encryptor 215, decryptor 220, memory interface 225, display interface 230, and application manager 235. These components may be implemented in a computing environment relative to either or both of client devices 105 and 110, and may be stored in a corresponding memory storage device. By way of example, apparatus 200, which may also be considered to be a programmable application, may reside on a memory device of either of client devices 105 and 110. For purposes of illustration, the application or program, including executable program components, are illustrated herein as discrete blocks, although it is recognized that such programs and components reside at various times in different storage components of the corresponding client device, and may be executed by at least one data processor of the computer.

Communicator 205 may refer to a module or component that is designed, programmed, and/or configured to, e.g., transmit and receive, at least, text messages, multi-media messages, emails, etc., to and from another device, via a wireless text messaging service, e.g., SMS or MMS; the Internet, WiMAX™, Wi-Fi™, Bluetooth™, a wireless local area network, and other analog and digital wireless voice and data transmission technologies, e.g., GSM, CDMA, LTE, etc. Communicator 205 may be further designed, programmed, and/or configured to transmit and receive communication requests, passwords, confirmation messages, encryption keys, etc. Unless context otherwise requires specific description of a format of message transmitted and/or received by communicator 205, reference will be made to a “message” or “messages” hereafter in this description.

User interface (UI) 210 may refer to a module or component designed, programmed, and/or configured to, e.g., receive user input that includes passwords and/or other text, audio, video, and/or biometric credentials to enable authorized users to participate in implementation of message protection. UI 210 may be further designed, programmed, and/or configured to receive any single or combination of the aforementioned forms of input to register a messaging application and/or a user of the messaging application as being authorized for implementation of message protection. UI 210 may be communicatively coupled to display interface 230 so as to be displayed to a user of a corresponding one of client devices 105 and 110.

Encryptor 215 may refer to a module or component designed, programmed, and/or configured to encrypt a message received and/or transmitted by communicator 205 or otherwise stored in a memory of a corresponding one of client devices 105 and 110. As non-limiting examples, encryptor 215 may be designed, programmed, and/or configured to encrypt such messages using a symmetric key encryption scheme or a public key encryption scheme. Thus, encryptor 215 is designed, programmed, and/or configured to receive or otherwise access an encryption key that may be stored locally in a memory of a corresponding one of client devices 105 and 110 or, alternatively, remotely stored in an associated server.

Decryptor 220 may refer to a module or component designed, programmed, and/or configured to decrypt a message received and/or transmitted by communicator 205 or otherwise stored in a memory of a corresponding one of client devices 105 and 110. As non-limiting examples, decryptor 220 may be designed, programmed, and/or configured to decrypt such messages using a symmetric key encryption scheme or a public key encryption scheme. Thus, decryptor 220 is designed, programmed, and/or configured to receive or otherwise access an decryption key that may be stored locally in a memory of a corresponding one of client devices 105 and 110 or, alternatively, remotely stored in an associated server or computing device.

Memory interface 225 may refer to a module or component designed, programmed, and/or configured to access a local memory of a corresponding one of client devices 105 and 110 or, alternatively, a corresponding remotely located server or computing device. Memory interface 225 may be designed, programmed, and/or configured to access a local or remote memory in order to, at least, store messages received by communicator 205 or retrieve data or previously stored messages for transmission by communicator 205. Memory interface 225 may also retrieve data or previously stored messages for display thereof. Further, memory interface 225 may store, retrieve, and/or access messages and data in encrypted or decrypted form.

Display interface 230 may refer to a module or component designed, programmed, and/or configured to display notifications and/or messages for the benefit of a user of a corresponding one of client devices 105 and 110. For notifications and/or messages that require or solicit user input or feedback, display interface 230 may display UI 210.

Application manager 235 may refer to a module or component designed, programmed, and/or configured to, e.g., manage authorization of message protection on behalf of one or more authorized applications hosted on a respective one of client devices 105 and 110. Thus, application manager 235 may access a locally or remotely hosted memory to store and retrieve data pertaining to the authorization of a particular application hosted on a respective one of client devices 105 and 110. Accordingly, application manager 235 may identify or verify an application as being authorized for the purposes of message protection; and, in the same vein, application manager 235 may identify an application as not being authorized for the purposes of message protection.

The transactions handled or managed by application manager 235 may be implemented by utilizing one or more application program interfaces (API) that are compatible with APIs of various system architectures. More particularly, the APIs implemented by application manager 235 may be capable of creating new application domains within a process and customizing a newly created application domain, typically before managed code is executed in the new domain. That is, the APIs may be capable of managing, i.e., at least one of controlling and customizing, application domains further to the specifications provided by a manifest of a corresponding application or process. Further, one or more of the APIs implemented by application manager 235 may provide additional interfaces and methods to enable other APIs to participate in the execution of the programs, applications, and processes described herein.

Bus 202 may refer to an architectural module or component designed, programmed, and/or configured to implement logical functionality to transfer data in various forms between any of components 205, 210, 215, 220, 225, 230, and 235, in order to facilitate interaction between any two or more of such components for the purposes of message protection, in accordance with the embodiments described herein.

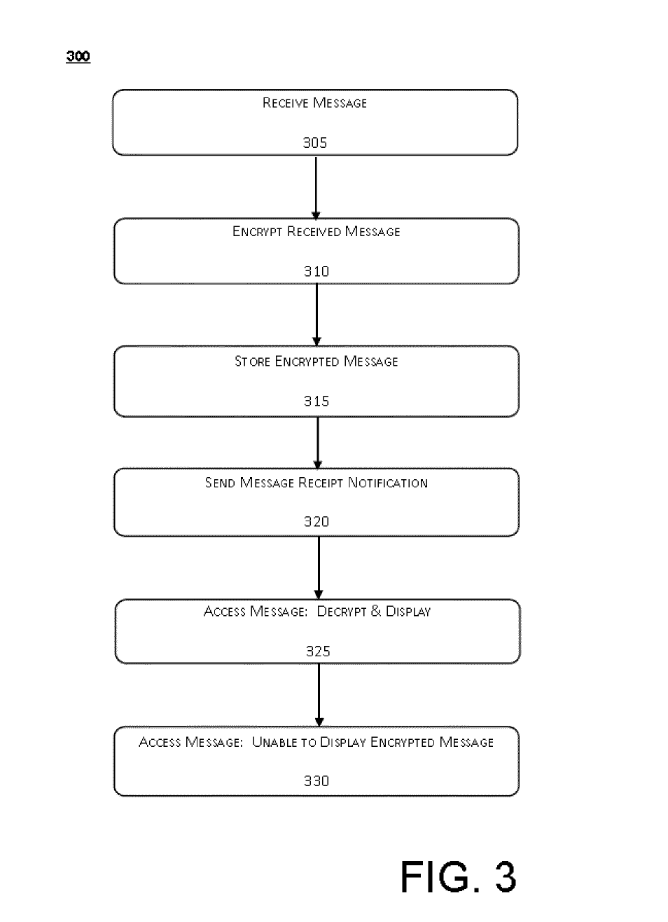

FIG. 3 shows an example processing flow 300 of operations for implementing at least portions of message protection. Process 300 may be implemented by any of the embodiments, or components thereof, referenced previously regarding FIGS. 1 and 2. Further, example process 300 may include one or more operations, actions, or functions as illustrated by one or more blocks 305, 310, 315, 320, 325, and 330. Although illustrated as discrete blocks, various blocks may be divided into additional blocks, combined into fewer blocks, or eliminated, depending on the desired implementation.

Processing flow 300 may be implemented to protect one or more messages that are both received at and transmitted by at least one of client device 105 and client device 110. For the purpose of clarity in explanation only, processing flow 300 is described herein in the context of client device 105 receiving message 107 from client device 110. Processing may begin at block 305.

Block 305 (Receive Message) may refer to communicator 205 receiving message 107. Message 107 may be any one of a text message, a multi-media message, email, etc., from client device 110, via a wireless text messaging service, e.g., SMS or MMS; the Internet; WiMAX™; Wi-Fi™; Bluetooth™; a wireless local area network; or other analog or digital wireless voice and data transmission technologies, e.g., GSM, CDMA, LTE, etc. Processing may proceed to block 310.

Block 310 (Encrypt Received Message) may refer to encryptor 215 encrypting received message 107, either as received by communicator 205 or after being otherwise stored in a corresponding memory of client device 105. Block 310 may include encryptor 215 encrypting message 107 using a symmetric key encryption scheme or a public key encryption scheme having received or otherwise accessed an encryption key that may be stored in a memory corresponding to client device 105.

Further, encryption at block 310 may be enabled, activated, or initiated upon entry of a user password via UI 210. That is, encryptor 215 may encrypt message 107 upon entry of the user's password. The password may be entered to UI 210 as any permutation of numerals, text characters, swiping patterns, image positioning, and/or any form of biometric verification, that has been registered with client device 105 in, e.g., a USIM (Universal Subscriber Identity Module Card). Processing may proceed to block 315.

Block 315 (Store Encrypted Message) may refer to memory interface 225 storing received message 107 in a local memory of client device 105 or, alternatively, a remotely located memory. Received message 107, stored into memory, may be encrypted by encryptor 215; or, alternatively, may be unencrypted, if encryptor 215 has not been enabled. Processing may proceed to block 320.

Block 320 (Send Message Receipt Notification) may refer to application manager 235 notifying or otherwise alerting applications hosted on client device 107 of the receipt and storing of message 107. In accordance with at least one embodiment, applications that are authorized or otherwise enabled to access and display unencrypted message 107 are alerted at block 320. Processing may proceed to block 325. According to at least one embodiment of message protection, further authorization may be required to display decrypted message 107 even after being authorized to access decrypted message 107. Such further authorization may be requested, provided, and/or received in the same manner as the authorization to access the protected version of message 107 described herein.

Block 325 (Access Message: Decrypt and Display) may refer to one or more of the notified authorized applications directly accessing, or being provided indirect access, to encrypted message 107. That is, an authorized application may directly retrieve encrypted message 107 from a local or remote memory corresponding to client device 105; or, alternatively, memory interface 225 may be programmed, designed, or otherwise configured to retrieve encrypted message 107 for the authorized application.

Block 325 may further refer to decryptor 220 decrypting message 107, retrieved by or for the authorized application, prior to, during, or after retrieval from the local or remote memory corresponding to client device 105. As stated above, the authorized application may access decrypted message 107 only upon verification of authorization. Hence, message 107 is protected. Processing may proceed to block 330.

Block 330 (Display Encrypted Message) may refer to an unauthorized application attempting to access message 107. If message 107 is encrypted, the unauthorized application is unable to display anything more than the encrypted version of message 107; however, if message 107 is decrypted, the unauthorized application is denied access to the message. Hence, message 107 is protected.

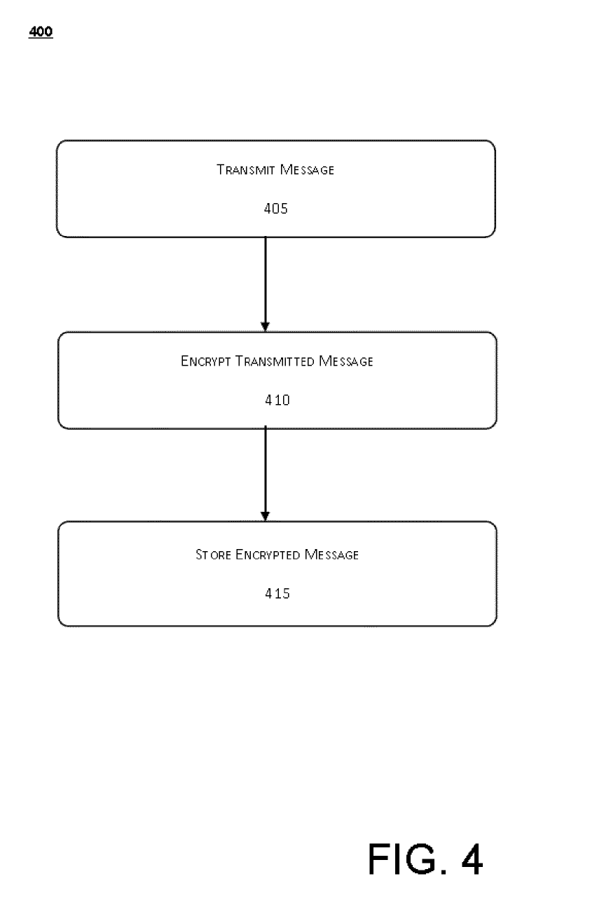

FIG. 4 shows another example processing flow 400 of operations for implementing at least portions of message protection. Process 400 may be implemented by any of the embodiments, or components thereof, referenced previously regarding FIGS. 1 and 2. Further, example process 400 may include one or more operations, actions, or functions as illustrated by one or more blocks 405, 410, and 415. Although illustrated as discrete blocks, various blocks may be divided into additional blocks, combined into fewer blocks, or eliminated, depending on the desired implementation.

Processing flow 400 may be implemented to protect one or more messages that are both received at and transmitted by at least one of client device 105 and client device 110. For the purpose of clarity in explanation only, processing flow 400 is described herein in the context of client device 105 transmitting message 107 to client device 110. Processing may begin at block 405.

Block 405 (Transmit Message) may refer to communicator 205 transmitting message 107, intended for client device 110. Message 107 may be any one of a text message, a multi-media message, email, etc., from client device 110, via a wireless text messaging service, e.g., SMS or MMS; the Internet; WiMAX™; Wi-Fi™; Bluetooth™; a wireless local area network; or other analog or digital wireless voice and data transmission technologies, e.g., GSM, CDMA, LTE, etc. Processing may proceed to block 410.

Block 410 (Encrypt Transmitted Message) may refer to encryptor 215 encrypting transmitted message 107, prior to, in parallel with, or after transmission by communicator 205; before or after being stored in a corresponding memory of client device 105. Block 410 may include encryptor 215 encrypting message 107 using a symmetric key encryption scheme or a public key encryption scheme having received or otherwise accessed an encryption key that may be stored in a memory corresponding to client device 105.

Further, encryption at block 410 may be enabled, activated, or initiated upon entry of a user password via UI 210. That is, encryptor 215 may encrypt message 107 subsequent to entry of the user's password; again, prior to, in parallel with, or after transmission by communicator 205. As indicated previously, the password may be entered to UI 210 as any permutation of numerals, text characters, swiping patterns, image positioning, and/or any form of biometric verification, that has been registered with client device 105 in, e.g., a USIM. Processing may proceed to block 415.

Block 415 (Store Encrypted Message) may refer to memory interface 225 storing transmitted message 107 in a local memory of client device 105 or, alternatively, a remotely located memory.

Once stored to memory, stored message 107 may be directly accessed or indirectly retrieved via memory interface 225 by messaging applications hosted on client device 105. Application manager 235 may allow unauthorized applications hosted on client device 105 to access the encrypted stored message 107, directly or via memory interface 225. These unauthorized applications will not be authorized or otherwise enabled to do more than display an encrypted version of stored message 107. However, application manager 235 may allow or otherwise enable an authorized application, authorized by virtue of its password, to access stored message directly, via decryptor 220, and/or via memory interface 225. Thus, application manager 235 may allow or otherwise enable an authorized application to access a decrypted version of stored message 107, which has been transmitted to client device 110.

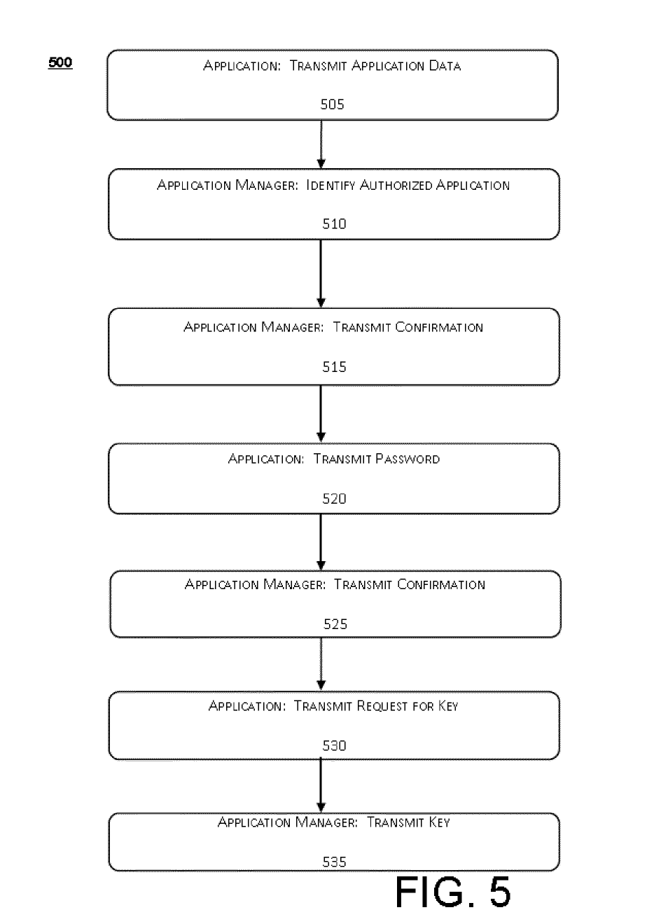

FIG. 5 shows another example processing flow 500 of operations for implementing at least portions of message protection. Process 500 may be implemented by any of the embodiments, or components thereof, referenced previously regarding FIGS. 1 and 2; more particularly process 500 may refer to interaction implemented between an authorized application, hosted on either of client device 105 and 110, and apparatus 200, particularly application manager 235, hosted on the same client device. Example process 500 may include one or more operations, actions, or functions as illustrated by one or more blocks 505, 510, 515, 520, 525, 530, and 535. Although illustrated as discrete blocks, various blocks may be divided into additional blocks, combined into fewer blocks, or eliminated, depending on the desired implementation.

Processing flow 500 may be implemented to protect one or more messages that are both received at and transmitted by at least one of client device 105 and client device 110. For the purpose of clarity in explanation only, processing flow 500 is described herein in the context of a messaging application hosted on client device 105 being authorized for protected access to message 107. Processing may begin at block 505.

Block 505 (Application: Transmit Application Data) may refer to the messaging application transmitting self-identifying information to application manager 235 of apparatus 200. The self-identifying information may include a name of the application, a version of the application, a hash code, a file size, etc. The self-identifying information may be transmitted in encrypted or unencrypted format. Processing may proceed to block 510.

Block 510 (Application Manager: Identify Authorized Application) may refer to application manager 235, either alone or in combination with any other module with apparatus 200, e.g., encryptor 215 and/or memory interface 225, identifying or verifying the messaging application as being authorized for the purposes of message protection with regard to, e.g., message 107. A determination as to whether the messaging application is authorized may be made by checking whether the received self-identifying application may be verified when compared to pre-registered data that may be stored in a memory corresponding to client device 105 that includes a list of registered/authorized applications. Processing may proceed to block 515.

Block 515 (Application Manager: Transmit Confirmation) may refer to application manager 235, either alone or in combination with any other module within apparatus 200, e.g., encryptor 215, transmitting a confirmation message to the messaging application, indicating that the messaging application is authorized for protected access to message 107. Processing may proceed to block 520.

Block 520 (Application: Transmit Password) may refer to the messaging application transmitting to application manager 235, either alone or in combination with any other module within apparatus 200, e.g., communicator 205, UI 210, and/or memory interface 225, user input that includes a password in the form of text, audio, video, and/or biometric credential input to enable an authorized user of the messaging application to have protected, e.g., decrypted, access to message 107. Processing may proceed to block 525.

Block 525 (Application Manager: Transmit Confirmation) may refer to application manager 235, either alone or in combination with any other module within apparatus 200, e.g., communicator 205, UI 210, and/or memory interface 225, transmitting a confirmation message to the messaging application, indicating that the received password has been verified and that the user is authorized for protected access to message 107. Processing may proceed to block 530.

Block 530 (Application: Transmit Request for Key) may refer to the authorized messaging application transmitting to application manager 235, either alone or in combination with any other module within apparatus 200, e.g., communicator 205, UI 210, and/or memory interface 225, a request for an encryption/decryption key that may be stored locally or remotely in a memory corresponding to client device 105. Processing may proceed to block 535.

Block 535 (Application Manager: Transmit Key) may refer to application manager 235, either alone or in combination with any other module within apparatus 200, e.g., communicator 205, UI 210, and/or memory interface 225, transmitting an encryption/decryption key to the authorized messaging application so that the authorized messaging application may provide a user with protected, e.g., decrypted, access to message 107 on client device 105.

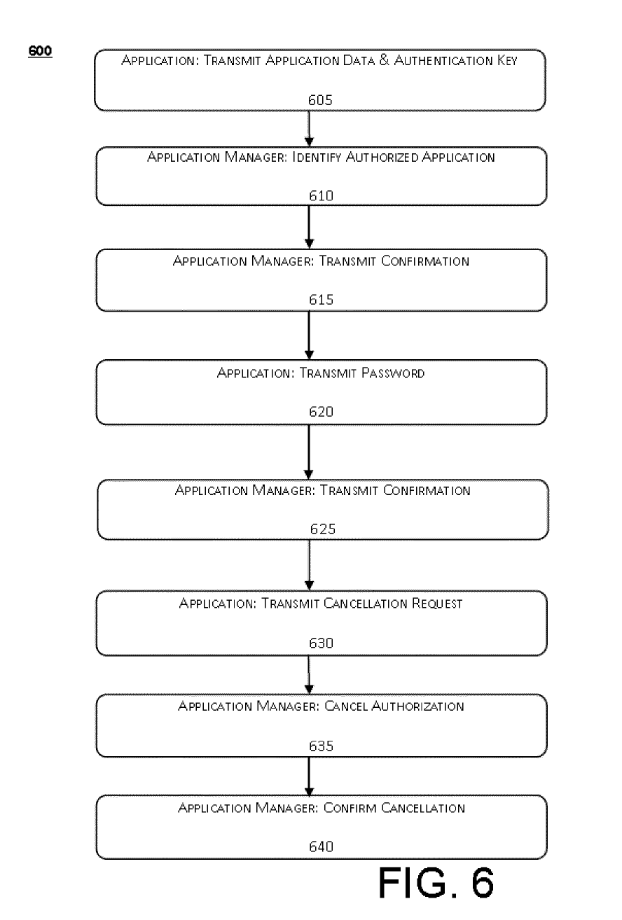

FIG. 6 shows another example processing flow 600 of operations for implementing at least portions of message protection. Process 600 may be implemented by any of the embodiments, or components thereof, referenced previously regarding FIGS. 1 and 2; more particularly process 600 may refer to interaction implemented between an authorized application, hosted on either of client device 105 and 110, and apparatus 200, particularly application manager 235, hosted on the same client device. Example process 600 may include one or more operations, actions, or functions as illustrated by one or more blocks 605, 610, 615, 620, 625, 630, 635, and 640. Although illustrated as discrete blocks, various blocks may be divided into additional blocks, combined into fewer blocks, or eliminated, depending on the desired implementation.

Processing flow 600 may be implemented to protect one or more messages that are both received at and transmitted by at least one of client device 105 and client device 110. For the purpose of clarity in explanation only, processing flow 600 is described herein in the context of a messaging application hosted on client device 105 being authorized for protected access to message 107 and then canceling the authorization. Processing may begin at block 605.

Block 605 (Application: Transmit Application Data and Authentication Key) may refer to the messaging application transmitting self-identifying information and an encryption/decryption key to application manager 235 of apparatus 200. The self-identifying information may include a name of the application, a version of the application, a hash code, a file size, etc. The self-identifying information may be transmitted in encrypted or unencrypted format. Processing may proceed to block 610.

Block 610 (Application Manager: Identify Authorized Application) may refer to application manager 235, either alone or in combination with any other module with apparatus 200, e.g., encryptor 215 and/or memory interface 225, identifying or verifying the messaging application as being authorized for the purposes of message protection with regard to, e.g., message 107. A determination as to whether the messaging application is authorized may be made by checking whether the received self-identifying application may be verified when compared to pre-registered data that may be stored in a memory corresponding to client device 105 that includes a list of registered/authorized applications. Processing may proceed to block 615.

Block 615 (Application Manager: Transmit Confirmation) may refer to application manager 235, either alone or in combination with any other module within apparatus 200, e.g., encryptor 215, transmitting a confirmation message to the messaging application, indicating that the messaging application is authorized for protected access to message 107. Processing may proceed to block 620.

Block 620 (Application: Transmit Password) may refer to the messaging application transmitting to application manager 235, either alone or in combination with any other module within apparatus 200, e.g., communicator 205, UI 210, and/or memory interface 225, user input that includes a password in the form of text, audio, video, and/or biometric credential input to enable an authorized user of the messaging application to have protected, e.g., decrypted, access to message 107. Processing may proceed to block 625.

Block 625 (Application Manager: Transmit Confirmation) may refer to application manager 235, either alone or in combination with any other module within apparatus 200, e.g., communicator 205, UI 210, and/or memory interface 225, transmitting a confirmation message to the messaging application, indicating that the received password has been verified and that the user is authorized for protected access to message 107. Processing may proceed to block 630.

Block 630 (Application: Transmit Cancellation Request) may refer to the authorized messaging application transmitting to application manager 235, either alone or in combination with any other module within apparatus 200, e.g., communicator 205, UI 210, and/or memory interface 225, a request to cancel authorization for the messaging application to have protected access to message 107. Processing may proceed to block 635.

Block 635 (Application Manager: Cancel Authorization) may refer to application manager 235, either alone or in combination with any other module within apparatus 200, e.g., memory interface 225, canceling authorization for a user of the messaging application to have protected, e.g., decrypted, access to message 107 on client device 105. Processing may proceed to block 640.

Block 640 (Application Manager: Confirm Cancellation) may refer to application manager 235, either alone or in combination with any other module within apparatus 200, e.g., communicator 205, UI 210, and/or memory interface 225, transmitting notification of the cancelation to the now-formerly authorized messaging application.

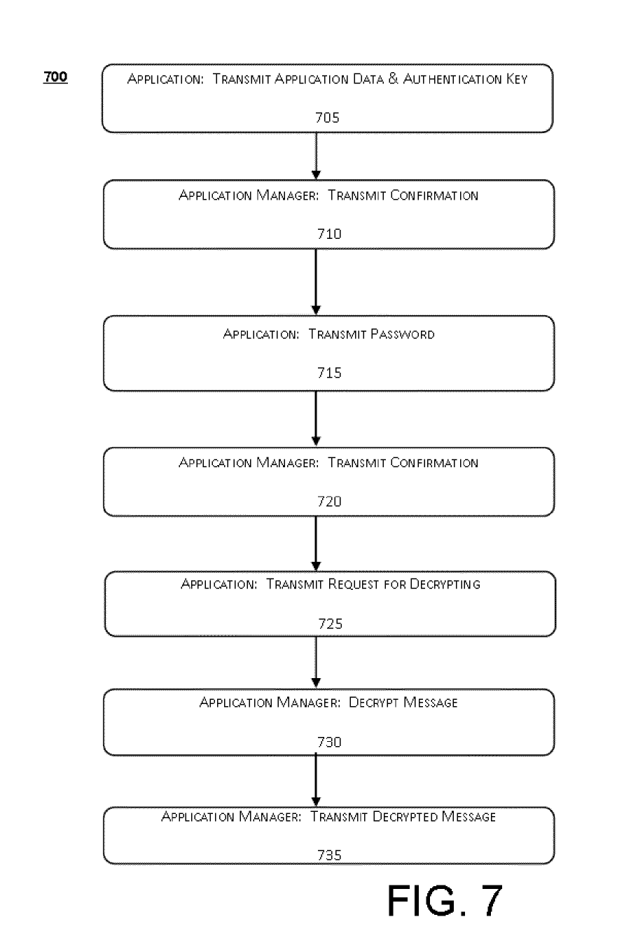

FIG. 7 shows another example processing flow 700 of operations for implementing at least portions of message protection. Process 700 may be implemented by any of the embodiments, or components thereof, referenced previously regarding FIGS. 1 and 2; more particularly process 700 may refer to interaction implemented between an authorized application, hosted on either of client device 105 and 110, and apparatus 200, particularly application manager 235, hosted on the same client device. Example process 700 may include one or more operations, actions, or functions as illustrated by one or more blocks 705, 710, 715, 720, 725, 730, and 735. Although illustrated as discrete blocks, various blocks may be divided into additional blocks, combined into fewer blocks, or eliminated, depending on the desired implementation.

Processing flow 700 may be implemented to protect one or more messages that are both received at and transmitted by at least one of client device 105 and client device 110. For the purpose of clarity in explanation only, processing flow 700 is described herein in the context of a messaging application hosted on client device 105 being authorized for protected access to message 107. Processing may begin at block 705.

Block 705 (Application: Transmit Application Data and Authentication Key) may refer to the messaging application transmitting self-identifying information and/or an encryption/decryption key to application manager 235 of apparatus 200. The self-identifying information may include a name of the application, a version of the application, a hash code, a file size, etc. The self-identifying information may be transmitted in encrypted or unencrypted format. The encryption/decryption key may be provided to application manager 235 of apparatus 200 so that, upon authorization, the messaging application may have protected, e.g., decrypted, access to message 107 on client device 105. Processing may proceed to block 710.

Block 710 (Application Manager: Transmit Confirmation) may refer to application manager 235, either alone or in combination with any other module within apparatus 200, e.g., encryptor 215, transmitting a confirmation message to the messaging application, indicating that the messaging application is authorized for protected access to message 107. Processing may proceed to block 715.

Block 715 (Application: Transmit Password) may refer to the messaging application transmitting to application manager 235, either alone or in combination with any other module within apparatus 200, e.g., communicator 205, UI 210, and/or memory interface 225, user input that includes a password in the form of text, audio, video, and/or biometric credential input to enable an authorized user of the messaging application to have protected, e.g., decrypted, access to message 107. Processing may proceed to block 720.

Block 720 (Application Manager: Transmit Confirmation) may refer to application manager 235, either alone or in combination with any other module within apparatus 200, e.g., communicator 205, UI 210, and/or memory interface 225, transmitting a confirmation message to the messaging application, indicating that the received password has been verified and that the user is authorized for protected access to message 107. Processing may proceed to block 725.

Block 725 (Application: Transmit Request for Decrypting) may refer to the authorized messaging application transmitting to application manager 235, either alone or in combination with any other module within apparatus 200, e.g., communicator 205, encryptor 215, and/or decryptor 220, a request for message 107, which may be stored locally or remotely in a memory corresponding to client device 105, to be decrypted for protected access by the authorized messaging application. Alternatively, the transmitted request may be for message 107 to be encrypted to ensure protected access to message 107 by authorized messaging applications on client device 105. Processing may proceed to block 730.

Block 730 (Application Manager: Decrypt Message) may refer to application manager 235, either alone or in combination with any other module within apparatus 200, e.g., encryptor 215, decryptor 220, and/or memory interface 225, decrypting message 107, which may be stored locally or remotely in a memory corresponding to client device 105. Processing may proceed to block 735.

Block 735 (Application Manager: Transmit Decrypted Message) may refer to application manager 235, either alone or in combination with any other module within apparatus 200, e.g., communicator 205, UI 210, and/or memory interface 225, transmitting decrypted message 107 to the authorized messaging application, thus providing protected, e.g., decrypted, access to message 107 on client device 105.

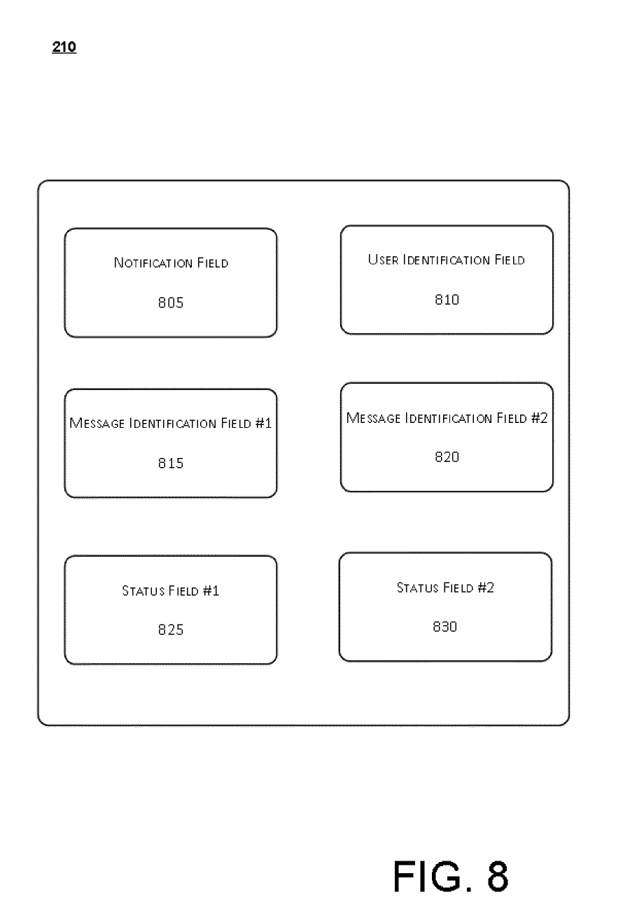

FIG. 8 shows an example user interface (UI) 210 by which at least portions of message protection may be implemented. UI 800 may refer to a graphical component of apparatus 200, and may refer to a module or component designed, programmed, and/or configured to, e.g., receive user input that includes passwords and/or other text, audio, video, and/or biometric credentials to enable authorized users to participate in implementation of message protection. UI 210 may be further designed, programmed, and/or configured to receive any single or combination of the aforementioned forms of input to register a user as being authorized for implementation of message protection. UI 210 may be communicatively coupled to display interface 230 so as to be displayed to a user of a corresponding one of client devices 105 and 110. UI 210 may be configured, designed, and/or programmed as a software module that resides, at least in part, in a memory of either or both of client devices 105 and 110, and may be executed by one or more processors on the respective client device.

As depicted, UI 210 may further be configured, designed, and/or programmed to display notification field 805, user identification field 810, message identification field #1 815, message identification field #2 820, status field #1 825, and status field #2 830. These data fields, which may be components or modules designed, programmed, and/or configured to display data as well as to receive user input are provided as an illustrative example only, and are not intended to be limiting of the embodiments of UI 210 in any manner.

Notification field 805 may refer to a module or component designed, programmed, and/or configured to display a notification that message 107 has, e.g., been received, stored, and/or encrypted on client device 105, awaiting access, or a request for access, by an authorized messaging application.

User identification field 810 may refer to a module or component designed, programmed, and/or configured to receive user input including, e.g., verification credentials to authorize and/or verification a messaging application for protected, i.e., decrypted access to message 107; a password to verify the user as being authorized to have protected, i.e., decrypted access to message 107; etc.

Message identification field #1 815 and message identification field #2 820 may respectively refer to a module or component designed, programmed, and/or configured to display identifying information regarding message 107 such as, e.g., the source, the intended recipient, the subject matter, identification of an attachment, etc.

Status field #1 825 and status field #2 830 may respectively refer to a module or component designed, programmed, and/or configured to display a status of message 107 for a requesting messaging application. For example, a status displayed for message 107 in status field #1 825 may indicate whether message 107 is encrypted or decrypted, whether the requesting messaging application or user thereof is authorized to have protected, e.g., decrypted, access to message 107 in accordance with a corresponding identifier displayed in identification field #1 815, etc.

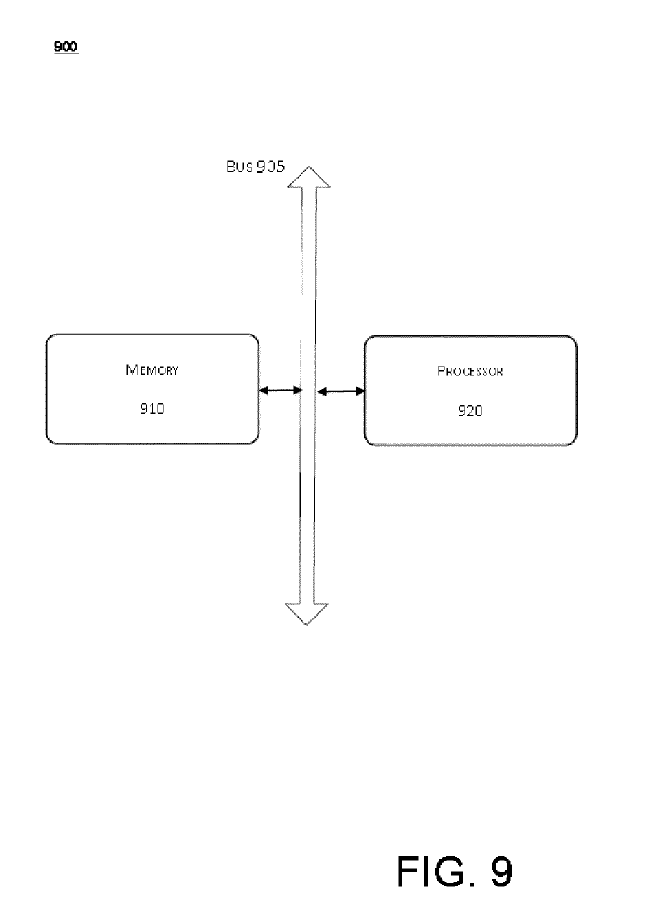

FIG. 9 shows an example computing device on which and by which at least portions of message protection may be implemented.

More particularly, FIG. 9 shows an illustrative computing embodiment, in which any of the processes and sub-processes of message protection may be implemented as computer-readable instructions stored on a computer-readable medium. The computer-readable instructions may, for example, be executed by a processor of a device, as referenced herein, having a network element and/or any other device corresponding thereto, particularly as applicable to the applications and/or programs described above corresponding to the configuration 100 for transactional permissions.

In a very basic configuration, a computing device 900 may typically include, at least, a system memory 910 and one or more processors 920. Computing device 900 may also include one or more input components, one or more output components, a display component, a computer-readable medium, and a transceiver.

Processor 920 may refer to, e.g., a microprocessor, a microcontroller, a digital signal processor, or any combination thereof.

Memory 910 may refer to, e.g., a volatile memory, non-volatile memory, or any combination thereof. Memory 910 may store, therein, an operating system, an application, and/or program data. That is, memory 910 may store executable instructions to implement any of the functions or operations described above and, therefore, memory 910 may be regarded as a computer-readable medium.

Processor 920 may refer to, e.g., a microprocessor, a microcontroller, a digital signal processor, or any combination thereof.

An input component may refer to a built-in or communicatively coupled keyboard, touch screen, or telecommunication device. Alternatively, an input component may include a microphone that is configured, in cooperation with a voice-recognition program that may be stored in memory 910, to receive voice commands from a user of computing device 900. Further, an input component, if not built-in to computing device 900, may be communicatively coupled thereto via short-range communication protocols including, but not limited to, radio frequency or Bluetooth.

An output component may refer to a component or module, which may be built-in or removable from computing device 900, that is configured to output commands and data to an external device.

A display component may refer to, e.g., a solid state display that may have touch input capabilities. That is, a display component may include capabilities that may be shared with or replace those of the aforementioned input components.

A computer-readable medium may refer to a separable machine readable medium that is configured to store one or more programs that embody any of the functions or operations described above. That is, a computer-readable medium, which may be received into or otherwise connected to a drive component of computing device 900, may store executable instructions to implement any of the functions or operations described above. These instructions may be complimentary or otherwise independent of those stored by memory 910.

A transceiver may refer to a network communication link for computing device 900, configured as a wired network or direct-wired connection. Alternatively, a transceiver may be configured as a wireless connection, e.g., radio frequency (RE), infrared, Bluetooth, and other wireless protocols.

Bus 905 may refer to an architectural module or component designed, programmed, and/or configured to implement logical functionality to transfer data in various forms between memory 910 and processor 920, in order to facilitate interaction between the components for the purposes of message protection, in accordance with the embodiments described herein.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

We claim:

1. A method performed under control of a device, comprising:
receiving a message;
encrypting the received message;
storing the encrypted message in a memory;
authorizing one or more applications to access the encrypted message stored in the memory;
notifying the one or more authorized applications of receipt of the message;
decrypting the encrypted message;
authorizing a first application among the authorized applications to display the decrypted message; and
permitting the first application to display the decrypted message.

2. The method of claim 1, further comprising:
permitting, a second application among the authorized applications that is not authorized to display decrypted message, to display the encrypted message.

3. The method of claim 1, further comprising:
transmitting a message;
encrypting the transmitted message; and
storing the encrypted message in the memory.

4. The method of claim 1, further comprising:
issuing an authentication key to the first application.

5. The method of claim 4, wherein the authorizing comprises:
authenticating the first application based on data regarding the first application as well as a password that is input to the respective applications.

6. The method of claim 5, further comprising:
receiving a request to cancel the authorizing for displaying decrypted message; and
canceling the authorizing for displaying decrypted message.

7. The method of claim 6, wherein the canceling comprises:
receiving a password; and
canceling the authorizing for displaying decrypted message upon verification of the password.

8. The method of claim 1, wherein the decrypting is performed by an internal decryption module of the first application.

9. The method of claim 1, wherein the decrypted message is displayed differently from a non-encrypted message stored in the memory by the first application.

10. The method of claim 1, further comprising:
displaying a decryption menu, by the first application, that includes options comprising:
decrypting a designated message,
decrypting all messages, and
decrypting and storing a designated message in the memory.

11. A device, comprising:
a communicator to send and receive a message;
an encryptor to encrypt the message;
a memory to store the encrypted message;
a notifier to notify, a plurality of applications that have authority to access the encrypted message, of receipt of the message;
a first application, installed on the device, to:
receive the notification from the notifier,
decrypt the encrypted message, and
display the decrypted message; and
a second application, installed on the device, to:
receive the notification from the notifier, and
display the encrypted message.

12. The device of claim 11, wherein the encryptor is to further encrypt a phone number to which the device transmits the message or from which the device receives the message.

13. The device of claim 11, wherein the first application is to further display the decrypted message differently from a non-encrypted message stored in the memory.

14. The device of claim 11, wherein the first application is to further display a decryption menu that includes options comprising:
decrypting one message,
decrypting all messages, and
decrypting and storing a designated message in the memory.

15. The device of claim 11, further comprising:
an application manager to manage the plurality of applications that have authority to access the encrypted message.

16. The device of claim 11, further comprising:
a USIM with a security applet that is configured to decrypt the encrypted message.

17. A computing device, comprising:
a memory; and
a processing unit to:
receive a message;
encrypt the received message,
store the encrypted message in the memory,
notify authorized applications of receipt of the message,
decrypt the encrypted message,
display the decrypted message one of the authorized applications, and
display the encrypted message by another of the authorized applications.
